(19) United States
(12) Patent Application Publication
(10) Pub. No.: US 2012/0043887 A1
(43) Pub. Date: Feb. 23, 2012

(54) Wireless power transmission system and associated devices

(76) Inventor: Steven Mesibov, DeLand, FL (US)

(21) Appl. No.: 13/199,005

(22) Filed: Aug. 17, 2011

Related U.S. Application Data
(60) Provisional application No. 61/401,741, filed on Aug. 18, 2010.

(51) Int. Cl. F21V 33/00; B60L 1/00; H05B 41/282; H01F 38/14

(52) U.S. Cl. 315/76; 307/104; 307/9.1; 315/256

(57) ABSTRACT

A wireless power transmission system comprises: a power transmitter, which includes a power amplifier that provides a sinusoidal waveform in the frequency range of about 20 to 500 kHz; a first loop antenna producing an alternating magnetic field within a selected area; a power receiver, which includes a second loop antenna located at least partially within the alternating magnetic field of the first antenna; and an electricity-consuming device connected to the output of the power receiver. Both transmitter and receiver preferably contain a capacitive circuit element to optimize tuning, which may be discrete capacitors or may rely on the self capacitance of the antenna(s). Applications of the system include: wirelessly powered lights for fans, boats, aquariums, display cases, etc.; wirelessly powered sensors and other devices for use with captive animals; and systems for transmitting useful power through construction materials to devices on the other side of walls or other structures.

### CROSS-REFERENCE TO RELATED APPLICATION

This application claims the benefit of Provisional Patent Application No. 61/401,741 by the present inventor, filed on Aug. 18, 2010, the entire disclosure of which is incorporated herein by reference.

### BACKGROUND OF THE INVENTION

1. Field of the Invention

The invention pertains to apparatus and methods for transmitting usable electric power over intermediate distances to power various electrical devices.

2. Description of Related Art

Ever since the early days of the industrial revolution there has been a need for transferring electrical power from one place to another. Typically this is done with wires and transformers with the resulting restrictions in location and movement. While the ability to safely transfer large amounts of power over long distances wirelessly may still be a future dream, it is now possible to transfer modest amounts of power over distances up to about 10 cm and more without the use of wires, interference with other electronic devices or a resultant hazard to people or other animals.

Wireless, close proximity (near field) power transfer and battery charging is well known and has been known since at least 1947 and widely used since the 1970's for toothbrushes and even for general electronic devices. For example, U.S. Pat. No. 2,415,688 teaches the use of induction devices for various appliances, motors, and the like; U.S. Pat. No. 3,840,795 teaches the use of an inductive charger to recharge the sealed battery in an electric toothbrush; U.S. Pat. No. 3,938,018 discloses a charger for electronic items, using high-frequency resonant circuits; and U.S. Pat. No. 4,031,449 discloses an electromagnetically coupled battery charger.

Most inductive energy transfer systems focus on charging batteries for mobile electronic devices including laptops, cell phones, PDA and the like. All of these devices can be charged within close proximity (1 to 3 mm) of the transmitting coil. Little effort has been placed on the need to transmit power over moderate distances from 5 cm to 3 m where many low powered applications potentially exist. In the past, most wireless power transfer devices used an “inductive” approach, which simply splits a transformer in half with the transmitter on one half and the receiver circuit on the other. While this approach has an efficient power transfer, the distance that power can be transferred effectively is typically limited to near contact ranges of less than about 12 cm.

### OBJECTS AND ADVANTAGES

Objects of the present invention include the following: providing a wireless power transmission system capable of transferring usable amounts of power over distances from 10 cm to 2 m; providing a wireless power transmission system using planar transmit and receive coils; providing a compact wireless power transmission system; providing a wireless power transmission system capable of transmitting usable amounts of power through construction materials, composite materials, and water; providing wirelessly-powered lighting fixtures for placement on moving objects such as fans, on movable objects such as display stands, and on book cases, easels, and other objects where hard wiring is impractical; providing wirelessly powered devices for boat hulls, bath tubs, and aquaria; and, providing wirelessly powered devices for animal cages and enclosures. These and other objects and advantages of the invention will become apparent from consideration of the following specification, read in conjunction with the drawings.

### SUMMARY OF THE INVENTION

According to one aspect of the invention, a wireless power transmission system includes:
a power transmitter comprising:
   a power amplifier that converts a DC level power supply into a sinusoidal waveform in the frequency range of 20 to 500 kHz;
   a first planar loop antenna; and
   a tuning capacitor that couples the power amplifier with the antenna;
a power receiver comprising:
   a second planar loop antenna; and
   a receiver tuning capacitor; and,
at least one electricity-consuming device connected to the output of the power receiver.

According to another aspect of the invention, a containment system for animals includes:
an enclosure for containing an animal in a captive state;
a power transmitter comprising a power amplifier that converts a DC level power supply into a sinusoidal waveform in the frequency range of 20 to 500 kHz; a first planar loop antenna; and a tuning capacitor that couples the power amplifier with the first antenna, the first planar loop antenna disposed adjacent to a surface of the enclosure and producing an inductive magnetic field within the enclosure;
a power receiver located within the enclosure, the receiver comprising a second antenna and a receiver tuning capacitor; and,
at least one electricity-consuming device connected to the output of the power receiver.

According to another aspect of the invention, a wireless power system for watercraft comprises:
a power transmitter comprising a power amplifier that converts a DC level power supply into a sinusoidal waveform in the frequency range of 20 to 500 kHz; and a first planar loop antenna disposed adjacent to an inner surface of the hull in a selected area of the watercraft, the first antenna producing an inductive magnetic field within the selected area;
a power receiver located on an outer surface of the hull, the receiver comprising a second planar loop antenna adjacent to the selected area of the watercraft and a receiver tuning capacitor; and,
at least one electricity-consuming device connected to the output of the power receiver.

According to another aspect of the invention, a wireless lighting system comprises:
at least one horizontal surface upon which selected objects may be displayed;
at least one movable stand for holding one or more of said selected objects;
a power transmitter comprising a power amplifier that converts a DC level power supply into a sinusoidal waveform in the frequency range of 20 to 500 kHz; and a first planar loop antenna disposed parallel to the horizontal surface, the first antenna producing an inductive magnetic field over at least part of the horizontal surface, and a tuning capacitor that couples the power amplifier to the first antenna;
a power receiver located on the movable stand, the receiver comprising a second planar loop antenna oriented parallel to the first loop antenna, a receiver tuning capacitor, and at least one lighting device connected to the output of the power receiver.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic illustration of a printed circuit board containing a power transmitting antenna and power amplifier circuit according to one example of the present invention.

FIG. 2 is a schematic illustration of a printed circuit board containing a power receiving antenna and receiver circuit according to one example of the present invention.

FIG. 3 is a schematic illustration of a wired power transmitting antenna according to another example of the present invention.

FIG. 4 is a schematic diagram of a power transmitting power amplifying circuit according to one example of the present invention.

FIG. 5 is a schematic diagram of a power receiver circuit tuned to the same frequency as the power transmission circuit of the previous figure.

FIG. 6 is a schematic illustration of a wirelessly powered lighting system for ceiling fans.

FIG. 7 is a detail of the lighting system in the previous figure.

FIG. 8 is a schematic illustration of a system of the present invention, configured to transmit power through a block wall.

FIG. 9 is a schematic illustration of a system of the present invention, configured to transmit power through a boat hull.

FIG. 10 is a schematic illustration of an aquarium containing a wireless power system for lights and other electrical devices.

FIG. 11 is a schematic illustration of a self-contained, wireless lighting module in accordance with one example of the invention.

FIG. 12 is a schematic illustration of a table containing a wireless power transmitter to deliver power to objects placed on the table.

FIG. 13 is a schematic illustration of a wireless charging station for simultaneously charging a large number of batteries.

FIG. 14 is a plot of relative transmit and receive efficiencies for various separation distances for 60 cm diameter transmit and receive antennas.

### DETAILED DESCRIPTION OF THE INVENTION

The present invention includes a relatively small, directional, high Q, low frequency, resonant, magnetic loop antenna approach to transferring power up to hundreds of watts in ranges from about 12 cm to 2 m.

The inventive wireless power transfer methods are uniquely designed for critical locations where direct wiring is impractical, unsightly or hazardous. The design can be considered for military, scientific, commercial, consumer, and medical applications. The ability to transfer electrical energy, safely and reliably through any non-metallic material including wood, cement, plastic, fiberglass or water makes the invention ideal for places where drilling holes and connecting wires is not desirable.

This wireless transfer method uses a high resonant, low frequency magnetic waveform that is designed to conform to FCC and various health and safety standards. As opposed to high frequency RF “E-Field” transmissions used by microwave ovens or cell towers, the human body is virtually transparent to and unaffected by an “H-Field” magnetic environment like the earth's magnetic field or even one thousands of times larger, such as those found in an MRI machine.

The inventive system includes a power amplifier that converts a DC level power supply into a sinusoidal waveform, preferably in the frequency range of about 20 kHz to 500 kHz. Whereas a half bridge design may be appropriate for low power applications, say, less than 100 watts, higher power applications may use a full bridge or similar design. Those skilled in the art of switch mode power supplies will easily be able to employ well known engineering principles and trade-offs needed to optimize a design for a particular application.

A tuning capacitor is provided to couple the power amplifier with an antenna. This forms a series resonant circuit and must be capable of carrying the entire current of the antenna and withstand the maximum voltage of the drive circuit equal to Q times the drive voltage. It preferably has a low dissipation factor in order to achieve a high Q so that power losses are kept low. (Applicant prefers a Q value of at least 25 for many contemplated applications.) Finally, it preferably maintains a stable capacitance value over time and the temperature range of operation in order that the capacitor/antenna circuit is kept as close to resonance as possible without retuning by the end user. Poly-propylene capacitors typically tend to have excessive drift with temperature. Therefore, a high voltage ceramic capacitor with an NPO-type dielectric is typically preferred. Applicant has further discovered that using lower voltage, lower capacitance, capacitors in parallel/series combination may be less costly than using a single large capacitor.

The power amplifier is connected, via the tuning capacitor, to a first planar loop antenna which is preferably as large as possible within the physical constraints of a particular application. The number of turns of wire, or loops of traces on a printed circuit board (PCB) or flex board of this antenna will depend upon the intended transmission range and amount of power to be transmitted. Generally, high frequency operation will transmit further and require a smaller antenna but has stricter limitations on the amount of current (ampere-turns) that can be conducted in the loop antenna in order to comply with FCC regulations. Lower frequency operation can be more efficient unless the greater loop antenna current resistive losses (I²R) exceed the losses that are encountered in the switching transistors and the wireless link efficiency.

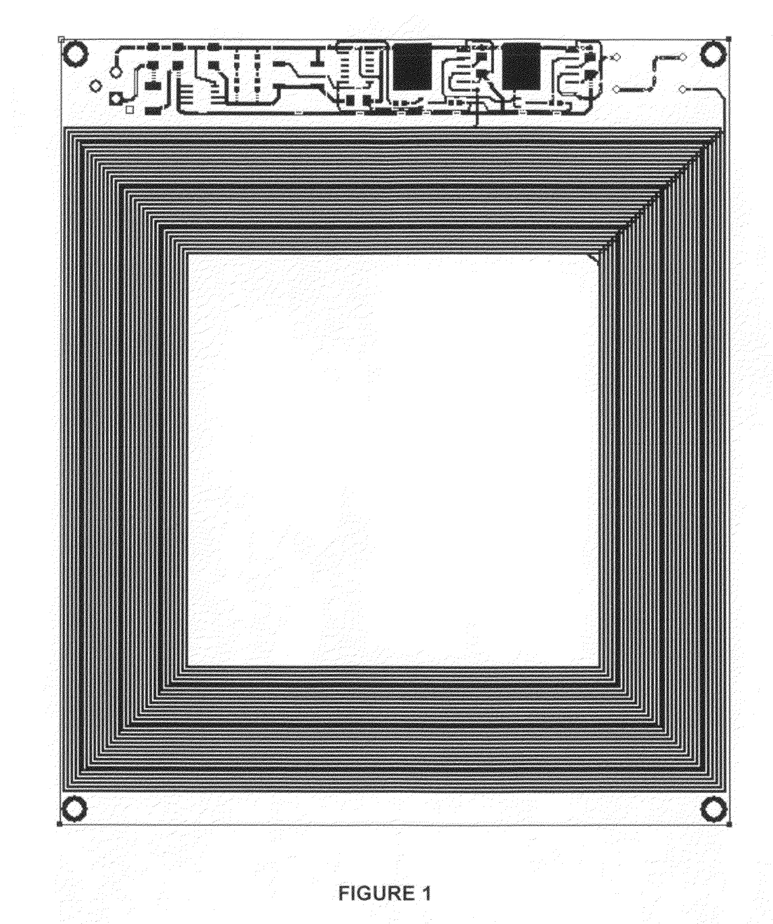

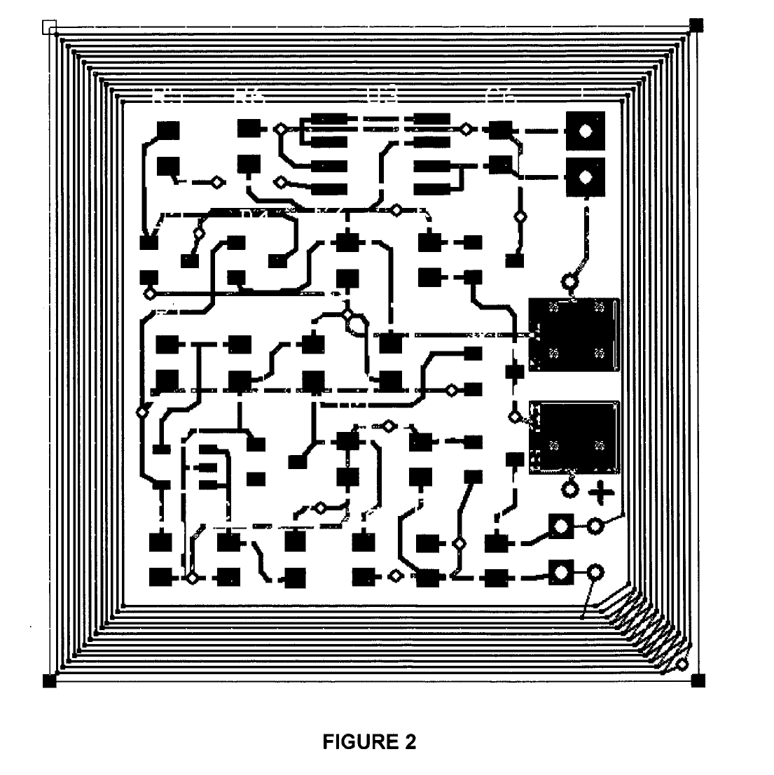

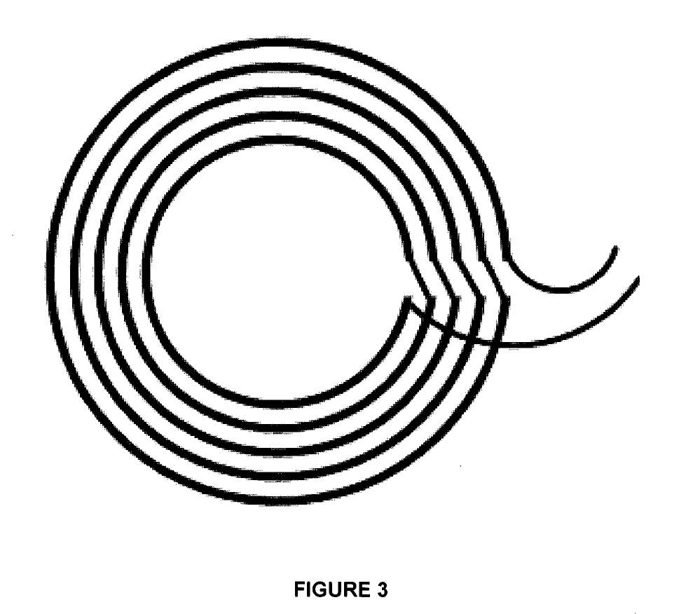

While not necessary for all applications claimed here, one preferred approach is to use thin profile “planar” transmit and receive antennas with no magnetic core material. In this way, the thickness of the device is minimized, magnetic core losses are eliminated and system efficiency is kept high. A PCB antenna design, FIGS. 1 and 2, can be used for small applications or a wired antenna, FIG. 3 may be appropriate for larger applications.

### Example

FIG. 1 illustrates schematically a layout for a power transmitter in which the planar transmitter antenna comprises a metallization forming ˜30 turns on a PCB; and the other components may be conveniently mounted on a printed circuit on the same board, as shown on the upper part of the drawing. It will be appreciated that the components may be mounted using plated through-holes, surface mount pads, or any other conventional means for populating a printed circuit.

### Example

FIG. 2 illustrates schematically a board layout for a power receiver tuned to the same frequency as the transmitter shown in FIG. 1. Again, the planar loop antenna is integral with the PCB. In this case, the other circuit elements are arranged on the board in the space enclosed within the turns of the planar loop antenna, thereby making optimal use of the available real estate so the receiver board can be as small as possible.

Those skilled in the art will appreciate that the term “PCB antenna” as used herein, refers both to rigid printed-circuit boards (also known as FR-4) and to flexible materials such as copper-on-flex. It will be shown in later examples that the antenna might be deployed on a somewhat curved surface, and in such cases a flex circuit would be preferred over a rigid circuit even though either one might function adequately. Further details of the loop antenna that the designer may consider include the skin effect losses, which increase at high frequency, and the proximity effect, which increases losses with wires conducting currents in near contact with each other. These effects require that the windings of the loop antenna be spaced a certain distance apart depending on frequency and the desired current to be carried. These effects can also be limited by using bi-filar or tri-filar windings. This decreases the total resistance losses in the wire by reducing the current carried in each wire. If this approach is used then the exact length of the inside wire(s) of the loop must be increased to compensate for the shorter length of the inside turn(s) and to ensure that the multiple wires carry current equally. The proximity effect can also be limited by using conductors with plastic, PVC, or PTFE insulation as opposed to enamel coated magnet wire. Although this uses more space, the wires are guaranteed to be a minimum spacing apart and can reduce losses by more than a factor of two.

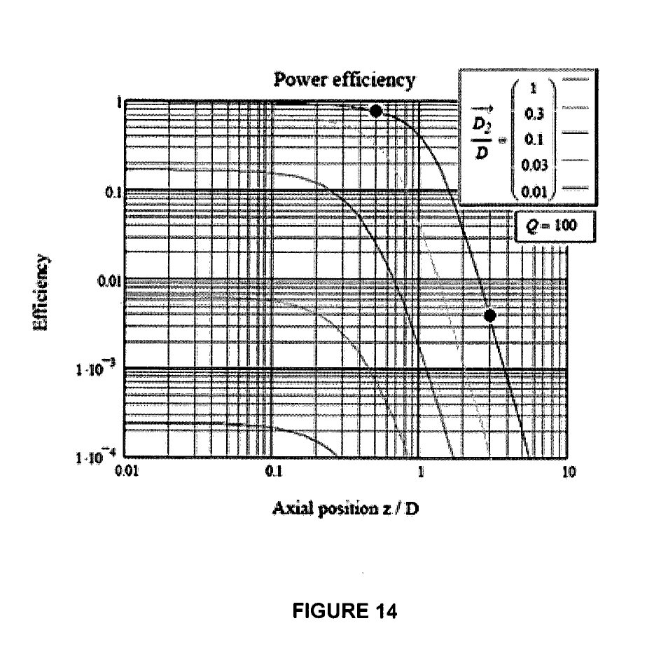

The transmitter antenna is sized for the maximum power transfer range desired. Typically the maximum effective range of this technique is on the order of 2 to 3 times the diameter of the transmitter depending on the total system efficiency desired. [See E. Waffenschmidt and T. Staring, “Limitation of Inductive Power Transfer for Consumer Applications”, 13^{th} European Conference on Power Electronics and Applications, EPE 2009, Issued on 8-10 Sep. 2009, pp. 1-10 for background information.] For example, with a 60 cm diameter transmit antenna and a 60 cm diameter receive antenna the power transfer efficiency at 30 cm could be as high as 80% but at 180 cm this would drop to about 0.4%. Still even at 180 cm, if the amount of power required is on the order of 25 mw to maintain a wireless sensor, the transmit antenna would only require on the order of 1 watt for effective operation. See FIG. 14 for some exemplary calculations, in which the two indicated points represent efficiencies of 80% at 15 cm and 0.4% at 180 cm for the case of both antennas having a diameter of 60 cm and a Q factor of 100.

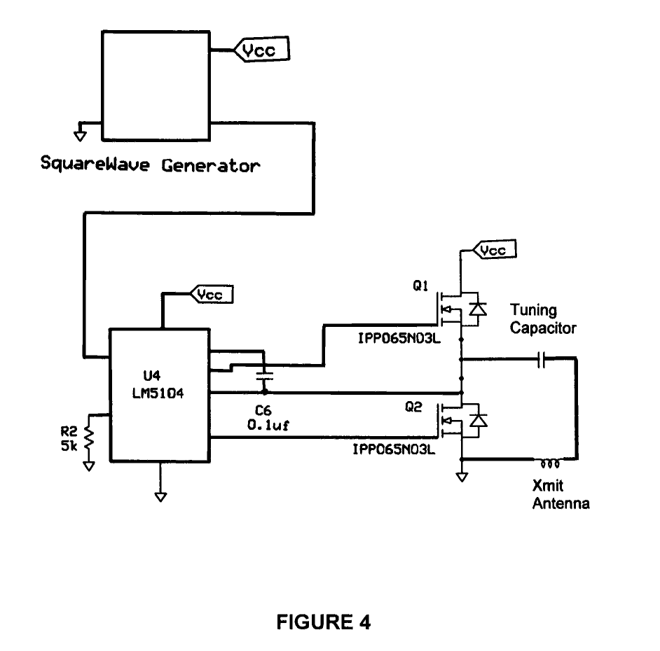

The transmitter amplifier design uses a circuit often found in switch mode power supplies: typically either a full bridge or half bridge driver, FIG. 4. However the inventive amplifier is preferably matched to a series resonant circuit that is precisely tuned to a particular frequency using a stable, high voltage, low dissipation factor capacitor. This allows for a maximum efficiency while minimizing the chances of electrical interference to any other circuitry in the vicinity that is not precisely tuned to that frequency.

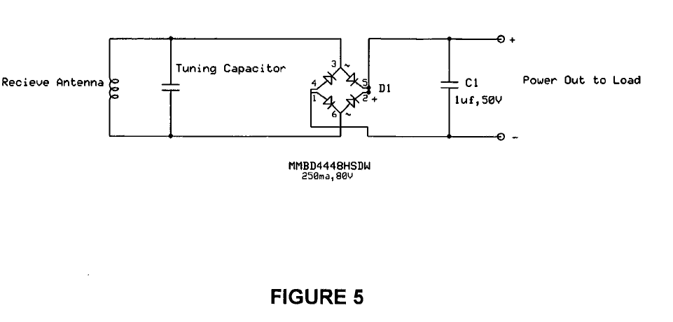

The receiver circuit, FIG. 5, is tuned to the same frequency as the transmitter. Key to this approach is the ability to achieve a high Q, highly resonant circuit for both the transmitter and especially the receiver. Whereas there is a limit to how large a magnetic field that can be generated for a particular frequency by the transmitter as established by the FCC and health organizations, there is no limit for the sensitivity or Q of the receiver. And as the power captured by the receiver over longer ranges is largely proportional to the square of the Q, it is desirable that the Q of the receiver circuit be as high as possible. By using low dissipation capacitors and separating the windings so as to minimize both the skin effect and proximity effect, a high Q circuit is achieved. For many applications, Q≧25 is preferred.

The receiver includes a planar loop antenna, a simple surface mount or chip inductor antenna, or a through hole inductor antenna, which should preferably be as large and with as many turns as the application and cost factors will allow. Whereas FCC regulations do not limit the size or number of turns of the receiving antenna, an excessive size or number of turns will increase its leakage capacitance, increase its resistance and reduce the effective power it can receive, especially as frequency is increased. Furthermore as the number of turns increases, the output voltage as well as output impedance increase as well. This often requires a step down transformer, which can be separate from the loop antenna but will increase cost, space requirements and power losses. In one example of the invention, another coil of fewer turns is placed inside the receiver planar loop antenna or around the inductor antenna. This fewer turned coil is designed to be matched to the voltage requirements of the load for maximum efficiency. Whether a fewer turned coil is used or not, the receiver planar loop antenna is to be designed with the same considerations of skin effect and proximity effect as that found with the transmitter planar loop antenna.

The receiver typically further includes a tuning capacitor, generally similar in all respects to the turning capacitor in the transmitter circuit except that it would typically have a lower voltage rating. A discrete capacitor is not always necessary on low power applications (<1 watt) where maximum efficiency is not required. In these cases the leakage capacitance of the receiver planar loop antenna or the receiver inductor antenna can be made larger so as to emulate a discrete tuning capacitor by providing the needed capacitance inherently. As used herein, therefore, the term “tuning capacitor” is intended to cover any source of capacitance, whether it is a discrete capacitor, an inherent capacitance of other circuit elements, or any combination of these.

The receiver may optionally contain a rectifier and filter circuit. This is an optional circuit when driving Light Emitting Diodes (LEDs), for example, because of the inherent rectifying ability of the LED itself. However, even for LEDs the performance of the circuitry is superior when using high speed diode(s) for this purpose. Because of the relatively high speed nature of the transmitted waveform (greater than 20 kHz) a full bridge rectifier is not always necessary to prevent optical flicker and in fact for many low power applications (less than 10 watts) a half bridge rectifier is typically more efficient due to one less diode drop.

Instead of using complex RF feedback mechanisms to generate just enough field to provide adequate power to the load, it is simpler and more cost effective to post regulate the received power where needed. However, as most applications are relatively fixed in distance between the transmitter and receiver, even this option is often not required.

The inventive wireless power transmission system enables the design of a number of novel devices, whose usefulness will be appreciated from consideration of the following examples:

### Example

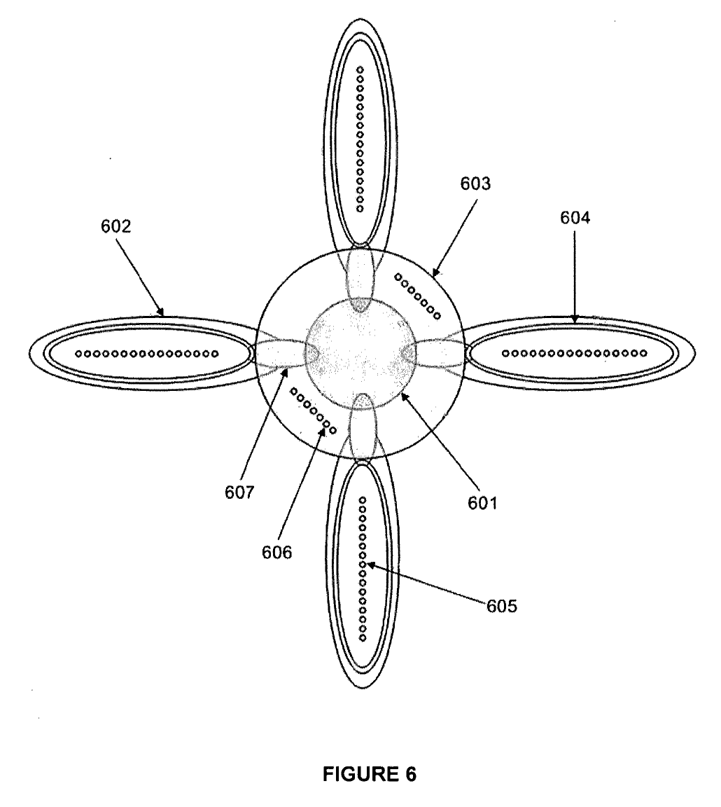

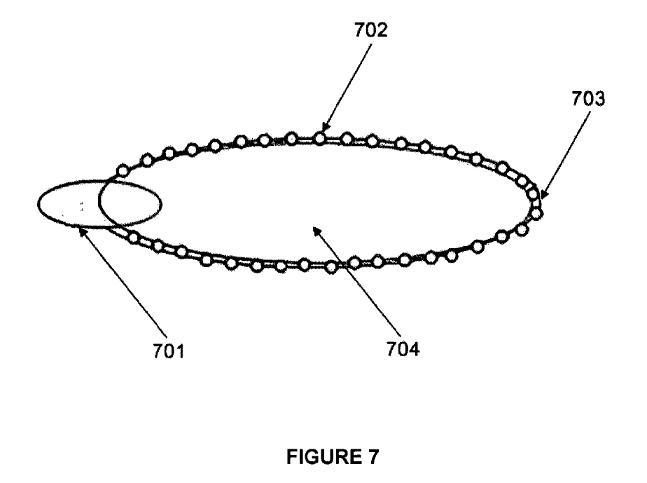

Ceiling fans often contain lighting fixtures to provide for overall room lighting. In general, the lighting fixture is stationary (i.e., non-rotating) because of the difficulty of having to supply power to the lights via commutators or other rotating contacts. The inventive power transmission system may be configured to transmit power to small lights (preferably LEDs or other highly efficient devices) that are mounted on or in the fan blades, thereby providing rotating lights without the need for moving electrical contacts, as shown schematically in FIGS. 6-7. FIG. 6 illustrates a ceiling fan including a motor 601 and four fan blades 602 connected to the motor with mounts 607. Transmitter antenna 603 is preferably generally coaxial with the rotating components. Each fan blade 602 contains a receiver circuit including a receiver antenna 604 and lights 605. Additional stationary lights 606 may also be provided elsewhere on the fixture. FIG. 7 shows schematically how lights can be arranged on a generally clear or translucent fan blade 704 connected to motor mount 701. Here, a string of lights such as LEDs extends around the periphery of blade 704, pointing inwardly. The receiver antenna 703 runs unobtrusively around the periphery of the blade.

The amount of power transmitted to each fan blade is dependent on the diameter of the center transmitter antenna and its distance from each fan blade. In one device that was built and tested, using a maximum 30 cm diameter planar transmitter antenna driven at 125 kHz, a total of 1.4 watts of power was received continuously on each of 5 separate fan blades no matter at what speed the fan was rotating. This was able to brightly light a string of 20 LEDs on each fan blade for an estimated light output of 200 lumens for all blades combined. As only 3.5 amperes were flowing in the 10 turns of the transmitter antenna this is significantly below the limitations established by the FCC for intentional transmitters for this frequency. Thus, more power could be transmitted and received if desired. It will be appreciated that in some cases, the transmitter antenna may be configured to provide power intermittently to individual fan blades as they rotate into its vicinity. It will be further understood that the transmitter antenna will preferably be oriented generally parallel to the plane of rotation of the fan overall; because of the pitch of the fan blades, individual receiver antennas might not be aligned strictly parallel to the plane of the transmitter antenna.

Those skilled in the art will appreciate that the invention can be easily modified to accommodate fans other than ceiling fans, and also to transmit power to other moving devices, such as reciprocating signs, store displays, etc. Furthermore, the electricity consuming device is not limited to lights but may include any device capable of operating on the available power.

In the preceding example, the electrical power was transmitted through air. It will be appreciated that the inventive wireless transmission system may equally well be used to transmit usable power through various non-magnetic dielectric materials, particularly construction materials, as described in the following examples.

### Example

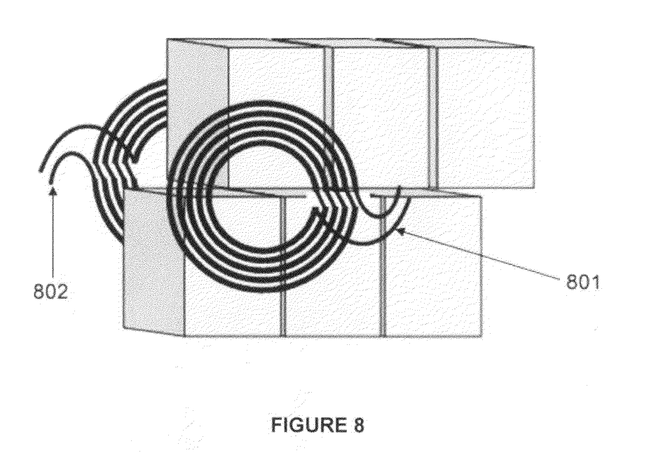

FIG. 8 shows an example of the use of the inventive system to transmit power through a concrete block wall or other nonmetallic structure, including wood, vinyl or masonite siding, plaster or drywall, etc. Here, transmitter antenna 801 and receiver antenna 802 are placed on opposite sides of a masonry wall so that usable power may be transmitted therethrough. In this example, the received power could be used to power small outdoor lights, illuminated house numbers, or other applications. In some instances, this system can function as a “wireless extension cord” or form the basis of an external power outlet that makes power available without having to bore through a wall, floor, or ceiling. This can be used for temporary applications such as outdoor Christmas or Halloween lights or more permanent installations such as that used for walkway lights or door chimes.

### Example

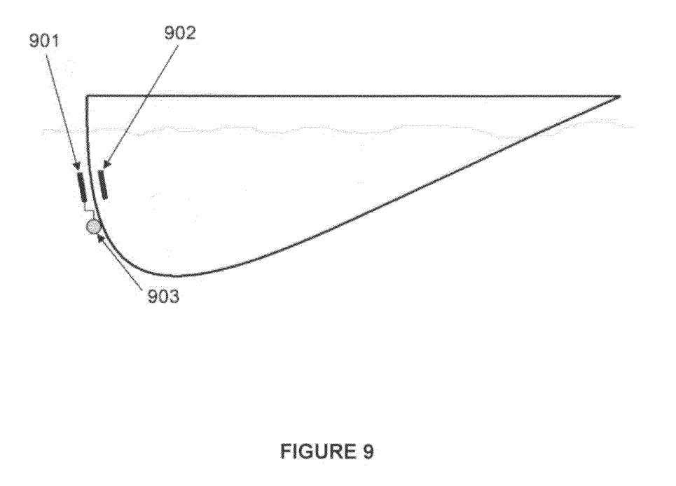

The invention may also be used to send power through the fiberglass hull of a boat, as shown generally in FIG. 9, allowing various electrical devices 903 such as lights, fish finders, etc., to receive power without having to compromise the hull by drilling power feed-throughs. In this example, the transmitter antenna 902 is placed on the inner surface of a (nonmetallic) boat hull and the receiver antenna and circuitry 901 (in a waterproof package or module) is placed on the outside surface adjacent to the transmitter. In this case, the transmit antenna 902 is preferably constructed as a flexible circuit, so that it may readily conform to the generally curved surfaces often found on boat hulls. However, the antenna may also be flat depending on the contour of the hull at the location of interest. It will be appreciated that a fish finder or other instrument 903 in accordance with the invention may further contain a means of transmitting data locally to a monitor onboard the boat. Such means may employ any suitable data transmission standards or protocols, such as Bluetooth or others familiar in the art. However, it has been shown that a reliable data stream can be transmitted on top of both the receiver or transmitter antenna but at a different operating frequency than that used for power transfer. The invention may similarly be used in aircraft for the same purpose.

For marine applications, the inventive device can be as simple as one or more underwater lights or as complex as a sonar based fish finder. In another variation of this aspect of the invention, a communication signal can be added on top of the power signal by adding transceiver devices to the power transmitter and receiver circuits, such that the electricity-consuming device may receive power as well as exchange data wirelessly. Similarly, a signal can be impressed upon the receiver antenna such that the transmitter antenna can now receive information from the receiver powered device (such as for a fish-finder). Alternatively separate smaller antennas can be added adjacent to or concentric with the transmitter and receiver antennas to achieve a complete communication channel that is independent of the power transmit and receive channel. As noted above, such communication may use Bluetooth or any other conventional wireless communication protocol.

### Example

The invention may also be used to power lighting fixtures on the inside of a pool structure such as a fiberglass bathtub, spa, whirlpool, swimming pool, or the like. As in the preceding examples, it eliminates the need to create power feed-throughs that are a source of maintenance or leakage problems. It further allows one to place such lights as a simple retrofit, provided access is available to the outside or underside of the tub near where the light will be placed.

As noted earlier, the invention uses a magnetic field to transmit power, and this field is relatively benign to animals and humans. The following examples illustrate the use of the invention in novel applications in animal husbandry and research.

### Example

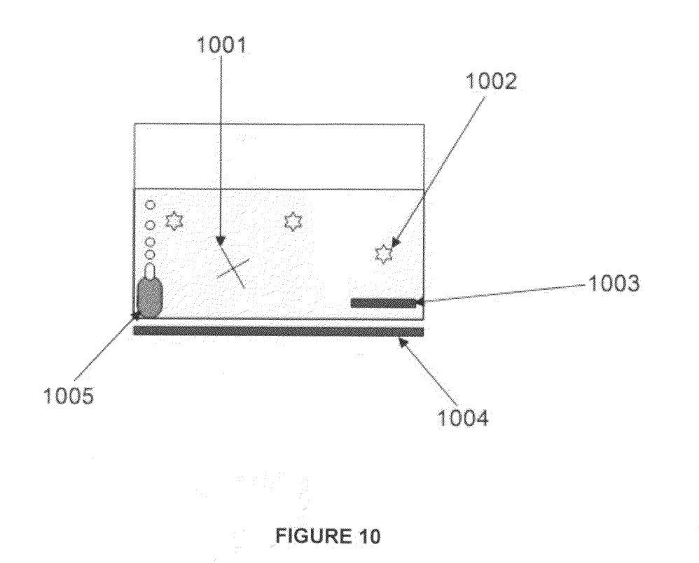

In aquariums used by hobbyists and researchers, there is often a desire to have various electrically-powered devices such as pumps, lights, etc., that might be partially or completely submerged. This creates a problem with unsightly wiring, as well as possible electric shock hazards (in fact, even if only small leakage currents exist because of a faulty device, the resulting electric fields in the water can be disruptive to the fish or other aquatic animals in the aquarium). As shown in FIG. 10, the inventive planar transmit antenna 1004 may be conveniently located on the underside of the tank, where it will be out of sight. Alternatively, the antenna may be incorporated into a colorful or scenic backdrop on the rear face of the tank, as is well known in the fish keeping hobby.

When a pump 1005, a small motorized wheel 1001, or heating pad 1003 is within 15 cm with the transmit antenna of approximately 0.2 m² (note neither transmit nor receive antennas need be round, square is acceptable) then a receiver antenna as small as 10 cm in diameter can provide over 20 watts of power. This is more than adequate to run a heating pad, a water filter, an air pump, or general lighting. Longer distances in the tank up to 60 cm away can still be overcome with even smaller antennas to power individual low power LED lights 1002. These LEDs can be fixed or floating randomly in the tank.

### Example

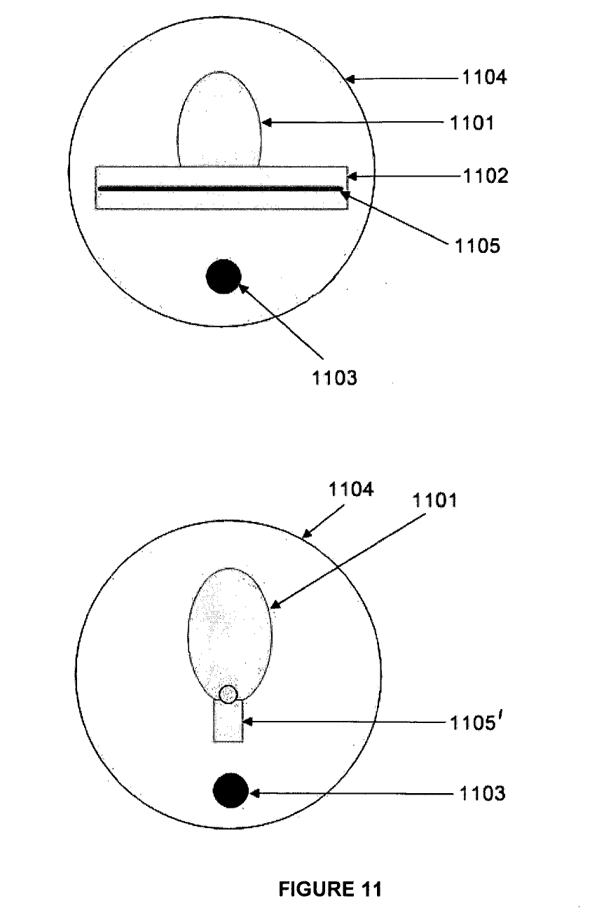

The system described in the preceding example may be used in a number of novel ways. Individual lighting modules may be constructed, as illustrated schematically in FIG. 11. In the drawing, a single module is shown, consisting of three essential elements: a receiver antenna 1105, 1105′; a receiver circuit 1102; and a light source 1101, which is preferably an LED, and more preferably a white-light LED. The circuit containing these three elements is preferably encapsulated in a waterproof, transparent or translucent medium 1104, such as a clear resin, which may be of any shape or size (spherical, cylindrical, etc.). The capsule may have a smooth surface, or it may be intentionally roughened to create a light diffusing effect. It may alternatively be faceted to create a lighted, jewel-like effect. The receiver antenna in this application may be a small inductor or a chip inductor 1105′, rather than a planar loop 1105, although it will be appreciated that a small, low-cost planar loop can be constructed as, for example, a thin-film metallization on a small disk of suitable dielectric such as a rigid FR-4 board or polyimide flex.

It will be appreciated that the self-contained lighting module described herein may be constructed to have either positive, neutral, or negative buoyancy, through the choice of resin, filler materials, etc. Thus, lights may be distributed in the aquarium such that some might float on the surface of the water, others might rest on the gravel at the bottom, and some might float randomly with water currents, thereby providing added interest and entertainment for the fish keeper or the fish. It will further be appreciated that the module, regardless of its overall buoyancy, may be constructed to include a small weight 1103 so that its center of gravity is located below its geometrical center; this would cause the module to orient itself with its antenna facing downward, parallel to the antenna on the underside of the tank for optimal efficiency.

In addition to the aforedescribed lighting module, other small electrical devices may likewise be constructed to operate in the aquarium, deriving their power from the wireless power supply. These may include, without limitation, various mechanical devices, pumps, decorative objects, digital thermometers, etc.

### Example

In the field of animal research, there is often the need to install small sensors and other devices on, or in, the lab animal to monitor some aspect of the animal's condition or health, such as temperature, respiration or heart rate, level of activity, etc. Such devices are generally powered by tiny batteries, thereby limiting their useful life. The inventive system may be used in this situation to provide power continuously or intermittently to such implanted devices, thereby eliminating the need for batteries.

### Example

Wireless lighting modules in accordance with the invention may also be conveniently used in a number of display applications. For example, individual lighted stands may be designed to hold small items such as cut glass, gems, crystals, etc., to be arranged in a display or sales case. A transmit antenna may be located discreetly under the shelf. Each individual stand would contain a receiver antenna, generally arranged parallel to the transmit antenna, a receiver circuit, and a small lighting device. Thus, each stand would incorporate a completely self-contained lighting module similar to that described for use in aquariums and illustrated schematically in FIG. 11.

In a variation of the system described in the previous example, rather than using a separate lighted stand, individual objects may have the power receiver and lighting element integrated directly into them, as described in the following example.

### Example

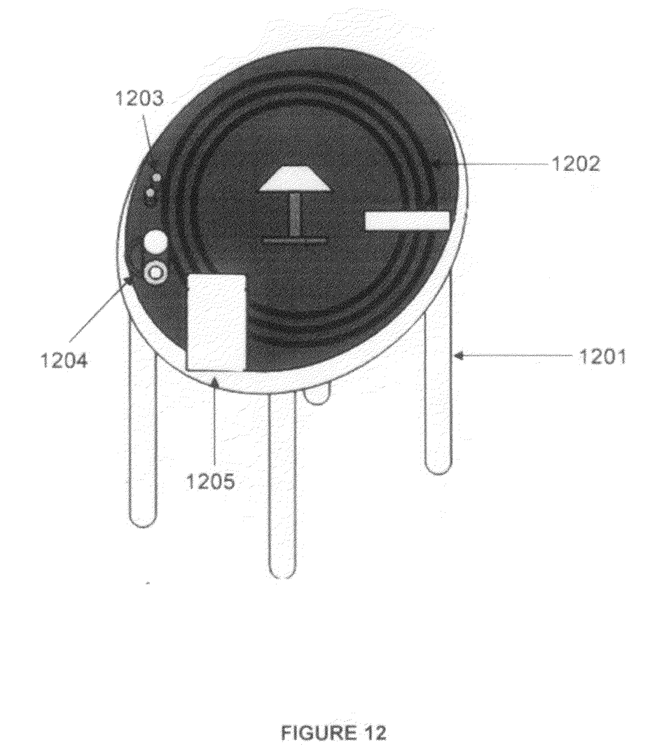

The power transmitter may be incorporated into a table (at a restaurant, for instance), with the antenna 1202 on the upper or underside of the table 1201, so that wirelessly powered lamps, lighted menus 1205, lighted drinking glasses 1204, utensils, casino chips 1203, or other novelties may be placed on the table without the need for wires or batteries, as shown generally in FIG. 12.

### Example

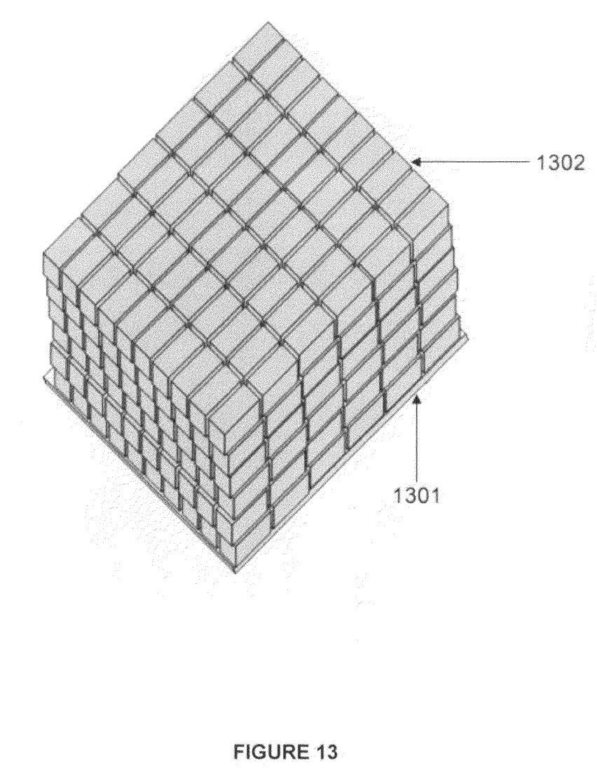

Because the invention provides wireless power delivered to a larger area and distance than conventional wireless battery chargers, the system may be used to charge a large number of batteries simultaneously, as shown schematically in FIG. 13. Here, the transmitter antenna 1304 is disposed at the bottom of a large array of battery packs 1302, each of which would typically have its own receiver antenna and circuitry.

We claim:

1. A wireless power transmission system comprising:
a power transmitter comprising:
a power amplifier that converts a DC level power supply into a sinusoidal waveform at a selected frequency in the range of about 20 to 500 kHz;
a first planar loop antenna; and
a tuning capacitor that couples said power amplifier with said antenna;
a power receiver comprising:
a second planar loop antenna; and
a receiver tuning capacitor; and,
at least one electricity-consuming device connected to the output of said power receiver.

2. The power transmission system of claim 1 wherein said first and second planar loop antennas are both tuned to said selected frequency.

3. The power transmission system of claim 2 wherein said power transmitter and said power receiver comprise resonant circuits tuned to achieve a Q of at least 25 at said selected frequency.

4. The power transmission system of claim 1 wherein at least one of said first and second planar loop antennas comprises a metallization layer on a dielectric substrate.

5. The power transmission system of claim 1 wherein said dielectric substrate is sufficiently flexible to conform to a selected curved surface.

6. The power transmission system of claim 1 wherein each of said first and second planar loop antennas is sufficiently flexible to conform respectively to the inner and outer surfaces of a polymer composite boat hull.

7. The power transmission system of claim 1 wherein each of said first and second planar loop antennas is sufficiently flexible to conform respectively to the outer and inner surfaces of a polymer composite pool structure.

8. The power transmission system of claim 1 wherein said electricity-consuming device is selected from the group consisting of: lighting elements; light emitting diodes; mechanical devices; pumps; battery chargers; decorative objects; digital thermometers; sensors; sonar devices; fish finders; and communication devices.

9. The power transmission system of claim 1 further comprising data transceivers in communication with one another via said first and second planar antennas.

10. A wireless power system for watercraft comprising:
a power transmitter comprising a power amplifier that converts a DC level power supply into a sinusoidal waveform at a selected frequency in the range of about 20 to 500 kHz; and a first planar loop antenna disposed adjacent to an inner surface of the hull in a selected area of said watercraft, said first antenna producing an inductive magnetic field within said selected area;
a power receiver located on an outer surface of said hull, said receiver comprising a second planar loop antenna adjacent to said selected area of said watercraft and a receiver tuning capacitor; and,
at least one electricity-consuming device connected to the output of said power receiver.

11. The wireless power system of claim 10 wherein said power transmitter and said power receiver comprise resonant circuits tuned to achieve a Q of at least 25 at said selected frequency.

12. The wireless power system of claim 10 wherein each of said first and second planar loop antennas is sufficiently flexible to conform respectively to the inner and outer surfaces of said hull.

13. The wireless power system of claim 10 wherein said electricity-consuming device is selected from the group consisting of: lighting elements; light emitting diodes;
mechanical devices; sensors; sonar devices; fish finders; and communication devices.

14. The wireless power system of claim 10 further comprising data transceivers in communication with one another via said first and second planar antennas.

15. A containment system for animals comprising:
an enclosure for containing an animal in a captive state;
a power transmitter comprising a power amplifier that converts a DC level power supply into a sinusoidal waveform in the frequency range of 20 to 500 kHz; a first planar loop antenna; and a tuning capacitor that couples said power amplifier with said first antenna, said first planar loop antenna disposed adjacent to a surface of said enclosure and producing an inductive magnetic field within said enclosure;
a power receiver located within said enclosure, said receiver comprising a second antenna and a receiver tuning capacitor; and,
at least one electricity-consuming device connected to the output of said power receiver.

16. The containment system of claim 15 wherein said second antenna comprises a device selected from the group consisting of: planar loop antennas, inductors, and chip inductors.

17. The containment system of claim 15 wherein said enclosure comprises an animal cage and said electricity consuming device comprises a sensor to monitor a selected aspect of said animal's condition.

18. The containment system of claim 15 wherein said enclosure comprises a tank for containing aquatic animals and said electricity-consuming device is selected from the group consisting of: lighting elements; light emitting diodes; mechanical devices; pumps;
decorative objects; digital thermometers; and sensors.

19. A wireless lighting system comprising:
at least one horizontal surface upon which selected objects may be displayed;
at least one movable stand for holding one or more of said selected objects;
a power transmitter comprising a power amplifier that converts a DC level power supply into a sinusoidal waveform at a selected frequency in the range of about 20 to 500 kHz; and a first planar loop antenna disposed parallel to said horizontal surface, said first antenna producing an inductive magnetic field over at least part of said horizontal surface, and a tuning capacitor that couples said power amplifier to said first antenna;
a power receiver located on said movable stand, said receiver comprising a second planar loop antenna oriented parallel to said first loop antenna, a receiver tuning capacitor, and at least one lighting device connected to the output of said power receiver.

20. The wireless lighting system of claim 19 wherein said horizontal surface comprises a table top.

21. The wireless lighting system of claim 19 wherein said horizontal surface comprises a shelf in a display case.

22. A lighted ceiling fixture comprising:
an electric motor-driven ceiling fan having a plurality of fan blades;
a power transmitter comprising a power amplifier that converts a DC level power supply into a sinusoidal waveform at a selected frequency in the range of about 20 to 500 kHz; and a first planar loop antenna disposed generally parallel to the plane of rotation of said fan blades, said first antenna producing an inductive magnetic field at least intermittently over at least part of the surfaces of said fan blades, and a tuning capacitor that couples said power amplifier to said first antenna;
a power receiver located on at least one of said fan blades, said receiver comprising a second planar loop antenna oriented generally parallel to said first loop antenna, a receiver tuning capacitor, and at least one lighting device on said fan blade connected to the output of said power receiver.
